(19) United States
(12) Patent Application Publication
(10) Pub. No.: US 2025/0213905 A1
(43) Pub. Date: Jul. 3, 2025

(54) Fire Sprinkler Remodeling and Hot Work Guard

(71) Applicants: Thad Thomas McKellar, Rockvale, TN (US); Justin Tyler Sherrell, Murfreesboro, TN (US)

(72) Inventors: Thad Thomas McKellar, Rockvale, TN (US); Justin Tyler Sherrell, Murfreesboro, TN (US)

(21) Appl. No.: 18/989,260

(22) Filed: Dec. 20, 2024

Related U.S. Application Data
(60) Provisional application No. 63/617,343, filed on Jan. 3, 2024.

(51) Int. Cl. A62C 37/12; A62C 99/00

(52) U.S. Cl. CPC A62C 37/12; A62C 99/009

(57) ABSTRACT

A fire sprinkler head guard includes a lateral wall comprising a circumferential lower edge, a circumferential upper edge, and a hollow interior between the lower and upper edges, a distal base connected to the lower edge about a circumference thereof in a fluid-tight manner, and a proximal wall connected to the upper edge about a circumference thereof in a fluid-tight manner. The proximal wall defines a sprinkler opening shaped and sized to fit therein a standard sprinkler head configurations including commercial and residential and comprising an edge and one or more slits originating from the edge of the sprinkler opening and extending radially towards the circumferential upper edge.

### STATEMENT REGARDING FEDERALLY SPONSORED RESEARCH OR DEVELOPMENT

Not Applicable

### FIELD OF THE INVENTION

The present systems, apparatuses, and methods lie in the field of fire protection. The present disclosure relates to a temporary, hot work, fire sprinkler head guard preventing accidental discharge of a fire sprinkler during repairs, maintenance, or remodeling.

### BACKGROUND OF THE INVENTION

Remodeling, construction, maintenance repairs, or other types of work conducted around existing fire sprinklers heads goes on every day somewhere in the world. Risk exists during such activities of accidentally setting off a fire sprinkler head by blunt force to the sprinkler head or through exposing it to a heat source, such as a soldering torch, while working in proximity of the sprinkler head. One of the biggest challenges for contractors and building owners alike is to maintain fire sprinkler protection during this work without causing an accidental discharge. Accidental discharges can cause hundreds of thousands of dollars of damage to finishes, structures, equipment, and contents. In sensitive areas, the effects of water damage can risk lives, for example, when medical equipment or communications are disrupted.

Currently there are two basic options for performing work in proximity to a sprinkler head. In a first option, the entire fire sprinkler system is shut down while work is being performed, and, possibly, also between all breaks in the work when the repair, remodeling, etc., is still not complete. Sprinkler system shut down can be a tedious and time-consuming process, which can require fire alarm system overrides, notifications to the authorities having jurisdiction over the protective system, and conducting of fire watches, to name a few. Even when shut down as a precaution and with other precautions taken, a sprinkler head can still be damaged, causing the system to be drained, repaired, and refilled—a costly and time-consuming process. A second option is to leave the sprinkler system(s) in place and protect the individual sprinkler head at risk while work is being performed near that head. Current best practices for protecting the sprinkler head in the second option include wrapping the head with a wet towel or cloth or laying a welding blanket over the head. While these might be effective in preventing an accidental discharge, it is not a sound strategy for physical protection of any sprinkler head.

Several problems arise from these protection variants. For example, the wet-cloth method is often skipped in the process because it requires the worker to find a cloth, to wet the cloth, and, then, to wrap it carefully around the sprinkler head. When welding blankets are used to protect the head, many vendors do not regularly have them available on the job. Further, these blankets are cumbersome, and simply wrapping the sprinkler head without care can cause undesirable damage. With either variant, if the blankets or the towels are forgotten after being installed and they are not removed, the protection solution during repair prevents proper discharge by the sprinkler head in the case of a fire, thereby allowing a fire to spread before the head activates or not allowing it to activate at all.

Current devices do not reliably protect a fire sprinkler head from accidental discharge during construction, during hot work activities. or during any other activities that might have the potential to activate a sprinkler head undesirably. If the sprinkler head activates, current devices do not allow for the discharge of the head in the case of a fire event when the devices are accidentally left in place on the sprinkler head after the work is complete.

Thus, a need exists to overcome the problems with the prior art systems, designs, and processes as discussed above.

### SUMMARY OF THE INVENTION

The systems, apparatuses, and methods described provide a temporary, hot work, fire sprinkler head guard that overcomes the hereinafore-mentioned disadvantages of the heretofore-known devices and methods of this general type and that provide such features with a surety that the fire sprinkler head is protected from accidental discharge during construction, during hot work activities, or during any other activities that might have the potential to activate undesirably a sprinkler head. Herein, the systems, apparatuses, and methods refer to a fire sprinkler guard, a fire sprinkler head guard, and a fire sprinkler remodeling guard, to name a few. These and similar descriptors are used interchangeably to describe all the various exemplary embodiments disclosed, described, and/or depicted. The fire sprinkler head guard still allows for the discharge of the head in the case of a fire event even if accidentally left in place on the sprinkler head after the work is complete. During any construction or repair activity in the vicinity of a fire sprinkler head, the fire sprinkler guard protects the temperature sensitive bulb or fusible link from accidental activation from soldering torches and other nearby heat or flame generation, as well as providing protection from inadvertent physical blows from construction activity that might cause the accidental discharge of that sprinkler head.

Any person conducting any kind of work around one or more sprinkler heads can use the fire sprinkler head guard to prevent an accidental discharge that could cause substantial damage to physical property and possessions. General contractors, mechanical, electrical, and/or plumbing companies, and maintenance personnel are the typical users of the fire sprinkler guard. The fire sprinkler guard(s) can be easily installed and removed for each day's work. If accidentally left on, the fire sprinkler guard does not hinder proper functioning of the sprinkler head in the event of a fire.

In an advantageous exemplary embodiment, the exterior of the fire sprinkler guard is colored with one or more fluorescent colors to make it easier to spot when installed on a sprinkler head.

The guards described herein can be installed on almost all types of existing fire sprinkler heads: recessed, non-recessed, sidewall, upright or over, and exposed heads. In advantageous exemplary embodiments, the fire sprinkler head guard is made in one piece, is lightweight, and is easy to store, and is inexpensive for the level protection it provides. Alternatively, in other exemplary embodiments, the fire sprinkler guard has different pieces: a flexible piece or pieces where flexibility is needed and a rigid piece or pieces where flexibility is not relevant or not required.

Exemplary embodiments of the fire sprinkler protectors described herein protect both the sprinkler head and the release mechanism from accidental discharge from physical blows and from temporary heat exposure, but they also allow heat to transfer in a sufficiently short time (for example, between approximately 1 minute and approximately 5 minutes, more specifically, between approximately 1 minute and approximately 2 minutes), thereby permitting activation of the temperature sensitive bulb or fusible link in the case of an actual fire. When the sprinkler head activates to discharge liquid due to heat from fire, the fire sprinkler remodeling guard is blown off the sprinkler head by the force of the discharged liquid and falls to the floor harmlessly.

The fire sprinkler guard saves time and potential heavy losses and damages while not hindering the proper functioning of the fire sprinkler system. In medical and healthcare settings, for example, the fire sprinkler guard can stop equipment and communication breakdowns that can be life-threating. The herein-described fire sprinkler guards are more efficient and are more professional than workers finding and wetting towels or wrapping large heavy welding blankets around sprinkler heads.

The fire sprinkler guard is quick and easy to deploy onto and to remove off a fire sprinkler. It is lightweight and compact, making it easy to keep on hand and, thus, encourage the guard's use. A contractor just needs to keep a few of the herein-described fire sprinkler guards on hand, for example, in toolboxes and/or work vehicles. Being uniquely colored or made of a fluorescently colored material makes the fire sprinkler guard easy to spot, thus making it harder to forget to remove them at the end of work or the day.

With the foregoing and other objects in view, there is provided, a fire sprinkler head guard comprising a lateral wall comprising a circumferential lower edge and a circumferential upper edge and defining a hollow interior between the lower and upper edges. a distal base connected to the lower edge about a circumference thereof in a fluid-tight manner, and a proximal wall connected to the upper edge about a circumference thereof in a fluid-tight manner, the proximal wall defining a sprinkler opening shaped and sized to fit therein a fire sprinkler head and comprising an edge and at least one slit originating from the edge of the sprinkler opening and extending radially towards the circumferential upper edge.

With the foregoing and other objects in view, there is also provided, a fire sprinkler head guard comprising a lateral wall comprising an outer surface, a circumferential lower edge, and a circumferential upper edge and defining a hollow interior between the lower and upper edges, a distal base connected to the lower edge about a circumference thereof in a fluid-tight manner, and a proximal wall connected to the upper edge about a circumference thereof in a fluid-tight manner, comprising a lip protruding from the outer surface, defining a sprinkler opening sized to fit therein and self-secure around the fire sprinkler head and comprising an edge, and defining a set of slits originating from the edge of the sprinkler opening and extending radially towards the circumferential upper edge, and defining intermediate bendable flaps therebetween. The lateral wall, the distal base, and the proximal wall together form an integral, single-piece body and have a weight that permits ejection of the head guard from the fire sprinkler head when the fire sprinkler head discharges fire-dousing suppressant, the fire sprinkler head has a temperature sensitive trigger, and the material is configured to prevent external environmental heat greater than approximately 57° C. (135° F.) from transferring into the hollow interior in less than approximately 1 minute to permit activation of the temperature sensitive trigger of the fire sprinkler head after that time.

In accordance with another feature, the lateral wall, the distal base, and the proximal wall together form an integral, single-piece body.

In accordance with a further feature, the lateral wall, the distal base, and the proximal wall are of a material selected from one or more of aramid, modacrylic, wool, neoprene, closed cell fire-resistant moldable silicone, ceramic, polyester, polyvinyl chloride (PVC or Vinyl), low-density polyethylene (LDPE), polyethylene terephthalate (PET or PETE), polyoxymethylene (POM also referred to as polyacetal, acetal resin, polytrioxane, polyformaldehyde, and paraformaldehyde, and with the trade names DELRIN®/ERTACETAL®/ACETRON®/SUSTARIN C®)/POMALUX®), RISHON®, natural and synthetic rubber, high heat-resistant catalyzed silicone rubber, nitrile, ethylene propylene diene monomer (EPDM), styrene-butadiene rubber (SBR), butyl rubber, polybutadiene rubber, silicones, closed cell silicones, fluorosilicone, and heat resistant textiles, as well as a myriad of stiffer plastic formulas with various resistances to flames and heat and impacts, one or more of these materials being UL94-rated or higher. The body can be any of these materials, flexible or stiff or hard materials such as aluminum, steel, Kevlar, fiberglass, and carbon fiber. These stiff and hard materials can be lined or coated with the softer materials both inside and outside the body of the sprinkler head guard. Various combinations of a stiff and hard material distal wall and/or lateral wall and/or seating lip can be employed. All of which have or include material properties that allow for flexibility to enclose around the fire sprinkler body, trim, or flange, while being rigid and form-holding to stay secured and/or held together by mechanical, magnetized, or by product entry flaps. In an advantageous embodiment, the sprinkler head guard 40 is formed from multiple parts comprised of a fire-resistant flexible material. In the exemplary embodiment of high heat-resistant catalyzed silicone rubber, high heat is up to temperatures of approximately 294° C. (560° F.). While this material can stand prolonged exposure to such a high temperature, it can also withstand a direct flame, for example, from a plumbers torch at temperatures of up to approximately 1,982° C. (3,600° F.) for 15 to 20 seconds without breaching the material. Holding such a flame for that long is highly unusual during normal situations and should set off the sprinkler inside. However, short exposures, such as an accidental glancing blow or swipe of that torch will protect the sprinkler head without setting it off. This is in contrast to a short glancing blow on an unprotected sprinkler head that would set off the sprinkler head.

In an exemplary embodiment, the stiff or hard material version of the sprinkler head guard is formed in a clam shell configuration and can be spring loaded to open when a closing latch or link is released, whether released manually or by reaching a heat-releasing temperature with a heat-sensitive catch. Such a clam shell configuration is latched with a fusible link that activates/trips/fails at approximately 57° C. (135° F.), similar to the one within a sprinkler head shown, for example, in FIGS. 1, 2, and 7 to 9. Once the fusible link trips, the hard cover version open and falls away from the sprinkler head. Another exemplary embodiment can incorporate a small battery-powered LED light for a quick visual reminder and warning that the cover is still in place on the sprinkler head.

In accordance with an added feature, the fire sprinkler head has a temperature sensitive trigger and the material is configured to prevent external environmental heat greater than approximately 57° C. (135° F.) from transferring into the hollow interior in less than approximately 1 minute to permit activation of the temperature sensitive trigger of the fire sprinkler head after that time.

In accordance with an additional feature, the lateral wall, the distal base, and the proximal wall together form an integral, single-piece cylindrical body and the proximal wall is planar.

In accordance with yet another feature, the distal base is one of planar, dome-shaped, and hemispherical.

In accordance with yet a further feature, the sprinkler opening is centered in the proximal wall and has a diameter of between approximately 12.7 mm and approximately 25.4 mm.

In accordance with yet an added feature, the lateral wall comprises an outer surface and the proximal wall comprises a lip protruding from the outer surface.

In accordance with yet an additional feature, the lip protrudes from the outer surface between approximately 1 mm and approximately 4 mm.

In accordance with again another feature, the at least one slit is a set of slits selected from one of two slits radiating outward from the sprinkler opening, three slits radiating outward from the sprinkler opening, four slits radiating outward from the sprinkler opening, and five slits radiating outward from the sprinkler opening. The set of slits are spaced at equal distances from one another.

In accordance with again a further feature, the at least one slit defines intermediate bendable flaps therebetween.

In accordance with again an added feature, there is provided at least one magnet at the proximal wall adjacent the sprinkler opening.

In accordance with again an additional feature, the at least one magnet is ring-shaped and surrounds the sprinkler opening.

In accordance with still another feature, the at least one magnet is one of attached to and integral with the proximal wall.

In accordance with still a further feature, the sprinkler opening is sized to self-secure around the fire sprinkler head.

In accordance with still an added feature, at least one of the lateral wall and the distal base have a fluorescent exterior color.

In accordance with still an additional feature, the sprinkler opening is sized to fit over the fire sprinkler head that is at least one of a recessed fire sprinkler head, a non-recessed fire sprinkler head, a sidewall fire sprinkler head, an upright fire sprinkler head, an over fire sprinkler head, and an exposed fire sprinkler head.

In accordance with still another feature, the proximal wall is of a first material having a given hardness and an outer surface, and which further comprises a flexible gasket at the outer surface of the proximal wall, the gasket being of a second material that is softer relative to the first material.

In accordance with still a further feature, the lateral wall, the distal base, and the proximal wall have a weight that permits ejection of the head guard from the fire sprinkler head when the fire sprinkler head discharges fire-dousing suppressant.

In accordance with still an added feature, the lateral wall has a cross-sectional shape with an interior diameter between approximately 38 mm and approximately 102 mm and a height between approximately 76 mm and approximately 152 mm.

In accordance with still an additional feature, the lateral wall has a cross-sectional shape selected from one of circular, ovular, triangular, square, pentagonal, hexagonal, septagonal, and octagonal.

In accordance with still an additional feature, the hollow interior has an inner width of between approximately 38 mm and approximately 102 mm.

In accordance with a concomitant feature, the lateral wall has a thickness of approximately 1 mm to approximately 3 mm.

Although the systems, apparatuses, and methods are illustrated and described herein as embodied in a temporary, hot work, fire sprinkler head guard, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a fragmentary, perspective view of an embodiment of a prior art sprinkler head;

FIG. 2 is a fragmentary, perspective view of another embodiment of a prior art sprinkler head;

FIG. 3 is a perspective view from a proximal side of an exemplary embodiment of a fire sprinkler head guard;

FIG. 4 is a side perspective view of the fire sprinkler head guard of FIG. 3;

FIG. 5 is a perspective view from a distal side of the fire sprinkler head guard of FIG. 3;

FIG. 6 is a perspective view from a proximal side of another exemplary embodiment of a fire sprinkler head guard;

FIG. 7 is a perspective view of a prior art fire sprinkler head with a recessed escutcheon;

FIG. 8 is a perspective view of a prior art fire sprinkler head with a flat escutcheon;

FIG. 9 is a perspective view of a prior art fire sprinkler head with a protruding escutcheon; and

FIG. 10 is a side perspective view of the fire sprinkler head guard of FIG. 6 mounted on a prior art escutcheon.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized, and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider them as being the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

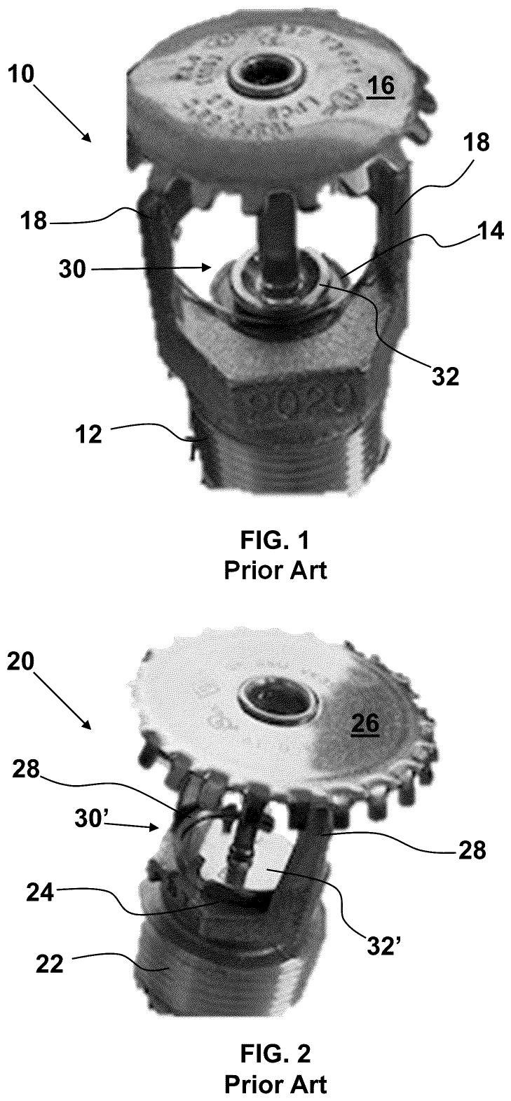

Typical commercial prior art sprinkler heads 10, 20 are shown in FIGS. 1 and 2. Each of the sprinkler heads 10, 20 have a base 12, 22, which may be threaded, to fluid-tightly connect at an input end to a non-illustrated fire-suppressant-supply system that conventionally supplies fire-dousing suppressant through a pipe at pressure. The base 12, 22 has an intermediate output 14, 24 that is fluid-tightly closed off by a trigger mechanism 30, 30′. Distally opposite the output 14, 24 is a suppressant distribution plate 16, 26 held away from the output 14, 24 by one or more distally extending frame parts 18, 28 of the base 12, 22. The suppressant distribution plate 16, 26 is also referred to as a deflector and the frame parts 18, 28 are also referred to as a cage. The distance between the output 14, 24 and the suppressant distribution plate 16, 26 is set so that, when the output 14, 24 is supplied with fire-suppressant at pressure, e.g., water, the water forcefully exits the output 14, 24 and strikes the output-facing side of the suppressant distribution plate 16, 26 (the under-surface thereof not illustrated in FIGS. 1 and 2). The suppressant distribution plate 16, 26 is shaped, in the configurations of FIGS. 1 and 2, as a circular platter with radially distal castellations at an angle to the plane of the platter. In such a configuration, the suppressant spreads substantially uniformly in all directions, i.e., 360 degrees, with higher concentrations of the suppressant exiting between the castellations to form a substantially circular fan of suppressant.

A common configuration for the trigger mechanism 30, 30′ is a plug 32, 32′ that fluid tightly seals off the output 14, 24 when held therein. The configurations shown in FIGS. 1 and 2 illustrate a glass ampule 34, 34′ securing the plug 32, 32′ within the output 14, 24 in this fluid-tight manner. The plug 32, 32′ remains fluid-tightly sealing off the output 14, 24 as long as the ampule 34, 34′ remains in place. If the ampule 34, 34′ is struck by a physical object sufficiently hard enough to break the glass, the plug 32, 32′ will eject, forced out of the output 14, 24 by the pressurized suppressant. Physical striking is an atypical use of the sprinkler head but it is a disadvantageous characteristic of the ampule 34, 34′ being made of glass. The designed (e.g., intended) mode for breaking the ampule 34, 34′ is by self-destruction caused by a level of heat in the immediate environment of the sprinkler head 10, 20 and is not intended to be broken by a physical strike (although, in certain circumstances, a user could intentionally strike the ampule 34, 34′ to trigger the mechanism 30, 30′). The ampule 34, 34′ is a cylinder filled with a glycerin-based liquid that expands when heated above a given temperature, a standard temperature of expansion being approximately 155° F. Accordingly, as soon as the ampule 34, 34′ is heated past this temperature, the liquid expands and breaks the glass (the glass being inelastic), thereby tripping the trigger mechanism 30, 30′ to release the pressurized suppressant. It is known by those in the fire suppression industry that heat used to weld, solder, or otherwise seal the pipes of most fire-suppressant-supply systems is much greater than the triggering temperature of the liquid in the trigger mechanism 30, 30′. It is also known that the pipes of the fire-suppressant-supply system, as well as the base 12, 22, are most typically made of metal that conducts heat well. Therefore, any repair, remodeling, or renovation of the pipes of the fire-suppressant-supply system will almost assuredly trip the trigger mechanism 30, 30′ if that work is close enough to the sprinkler head 10, 20 to transfer the generated heat.

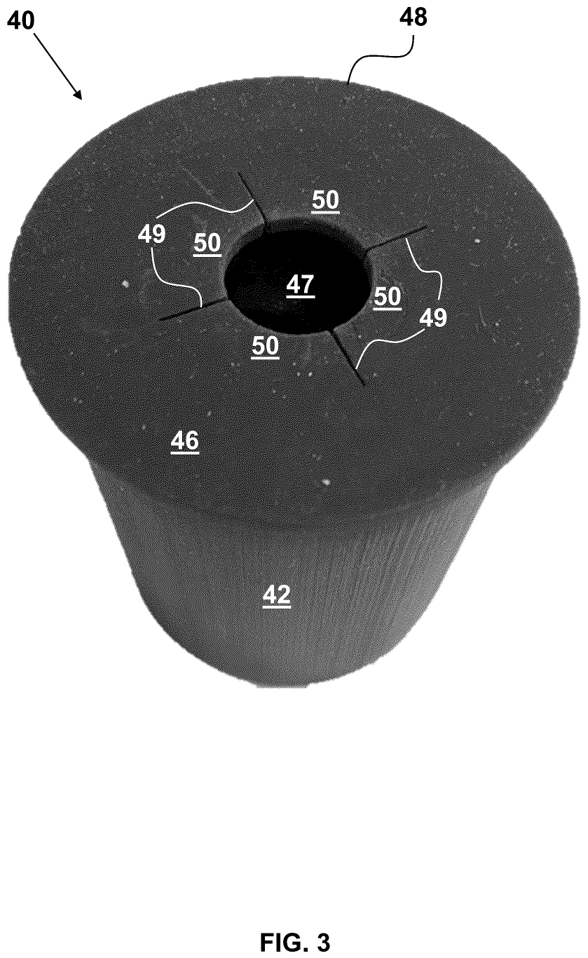

Described now are exemplary embodiments. Referring now to the figures of the drawings in detail and first, particularly to FIGS. 3 to 6, there is shown an exemplary embodiment of a temporary, hot work, fire sprinkler head guard 40. The entire sprinkler head guard 40 is a single piece body having a circumferential lateral wall 42 defining a hollow interior having an internal size and/or diameter to completely encircle a sprinkler head 10, 20 therein. The lateral wall 42 can have any cross-sectional polygonal shape including, for example, circular, ovular, triangular, square, pentagonal, hexagonal, septagonal, and octagonal. The lateral wall 42 depicted in the exemplary embodiment of FIGS. 3 to 6 is circular in lateral cross-section. In exemplary embodiments, the hollow interior of the lateral wall 42 has a diameter of between approximately 38 mm (1.5″) and approximately 102 mm (4″), more particularly, between approximately 51 mm (2″) and approximately 76 mm (3″), and, in particular, approximately 67 mm (2.625″). When the lateral wall 42 has a circular cross-sectional shape, the interior diameter is between approximately 38 mm (1.5″) and approximately 102 mm (4″), more particularly, between approximately 51 mm (2″) and approximately 76 mm (3″), and, in particular, approximately 67 mm (2.625″).

In exemplary embodiments, the lateral wall 42 has a thickness between approximately 1 mm (0.039″) and approximately 6 mm (0.24″), more particularly, between approximately 1 mm and approximately 4 mm (0.16″), and, in particular, between approximately 1 mm and approximately 3 mm (0.12″), but the thickness can vary depending on the material that is used. In exemplary embodiments, the height of the lateral wall 42 is between approximately 76 mm (3″) and approximately 152 mm (6″), more particularly, between approximately 83 mm (3.25″) and approximately 102 mm (4″), and, in particular, approximately 81 mm (3 3/16″).

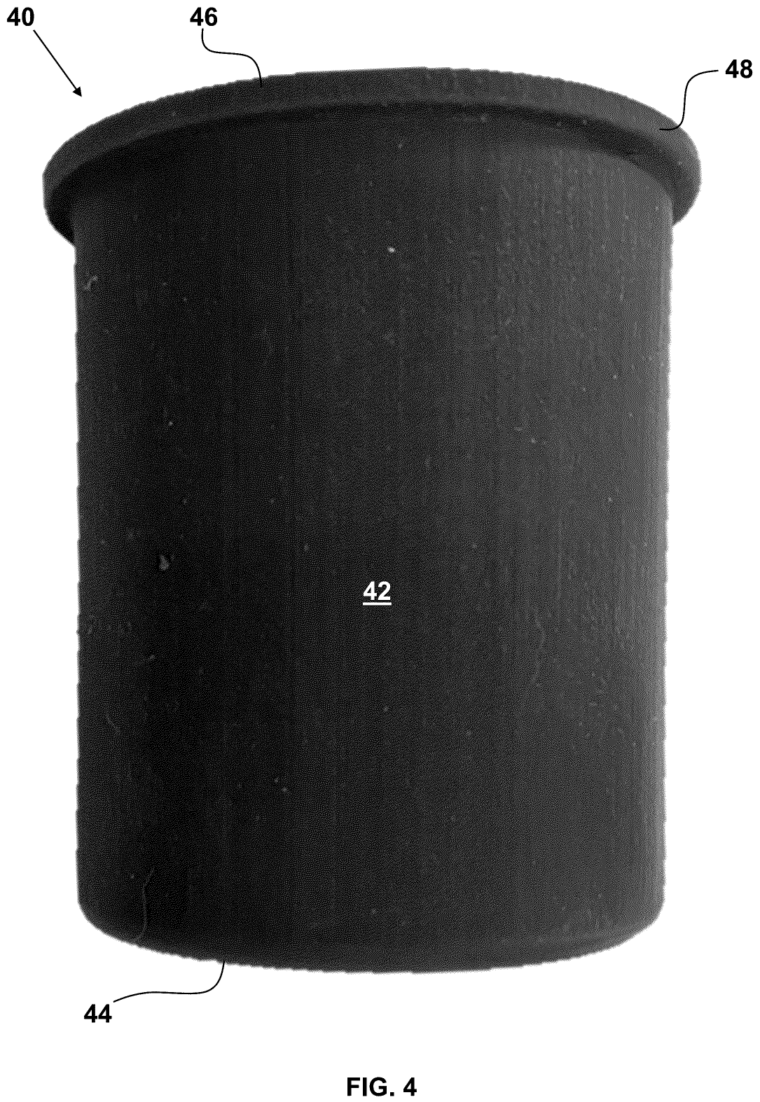

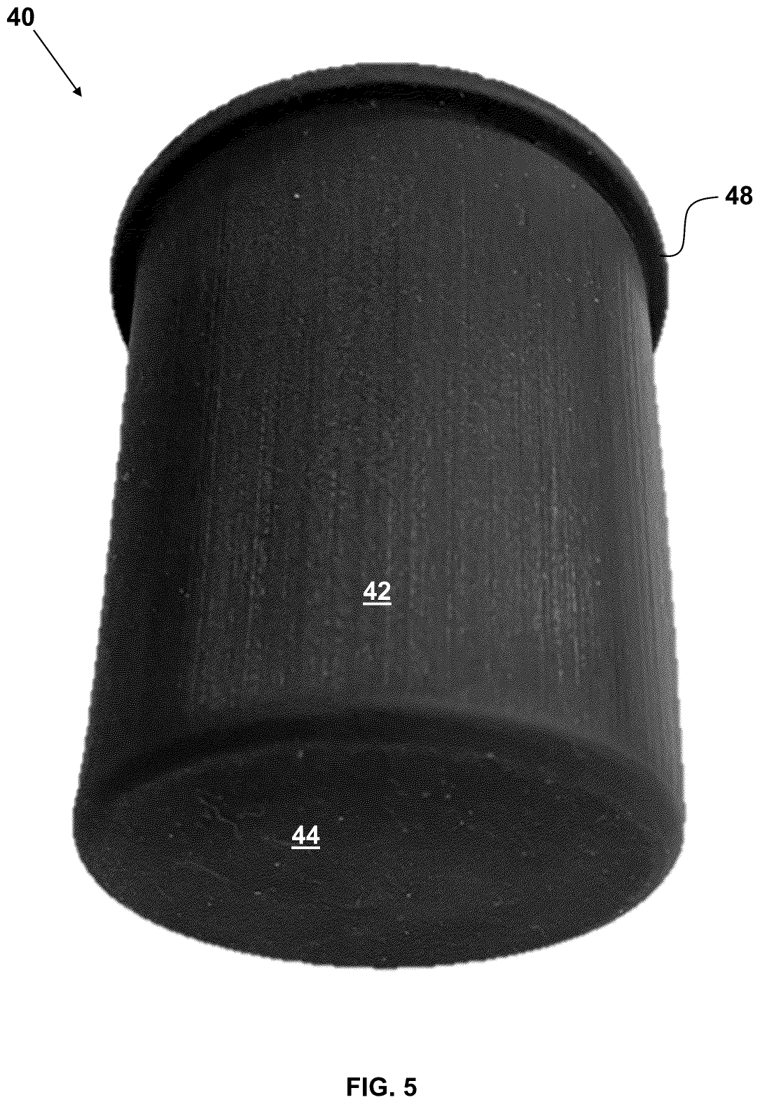

In the exemplary embodiment where the lateral wall 42 is a cylinder, a distal wall 44 of the cylinder is closed and flat. The edges of the distal wall 44 can be squared or they can be curved or chamfered as shown in FIGS. 4 and 5, for example. The wall that is opposite the distal wall 44 is the proximal wall 46 and the proximal wall 45 is also flat in these exemplary embodiments. In a particular exemplary embodiment, the proximal wall 46 has a seating lip 48 protruding from the outer surface of the lateral wall 42. This seating lip 48 allows the head guard 40 to seat against recessed sprinkler heads. The seating lip 48 can protrude between approximately 1 mm (0.04″) and approximately 4 mm (0.16″), more particularly, between approximately 3 mm (0.12″) and approximately 4 mm (0.16″), in particular, approximately 3.2 mm (⅛″).

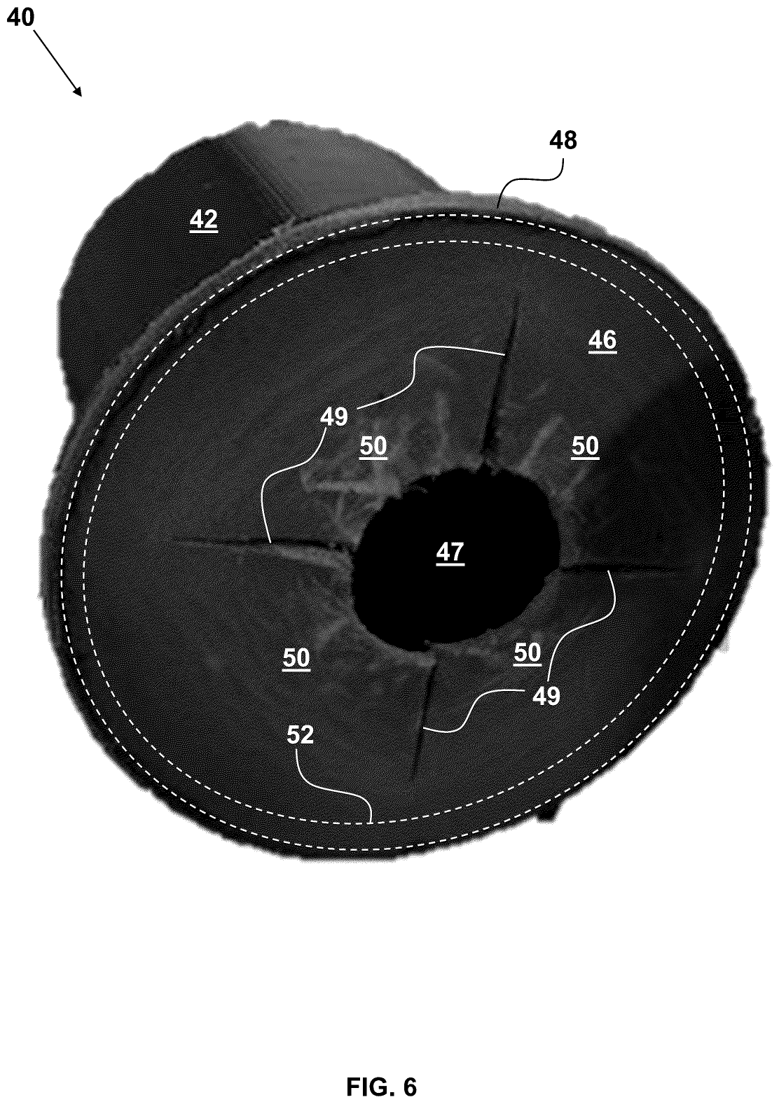

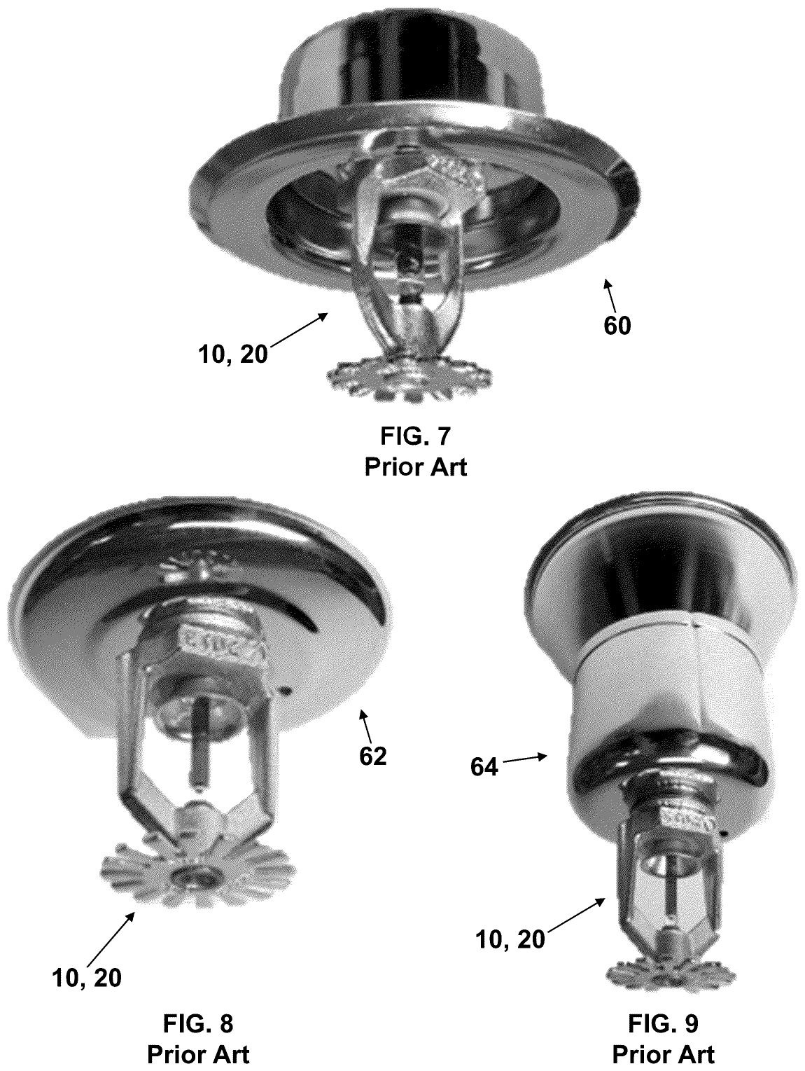

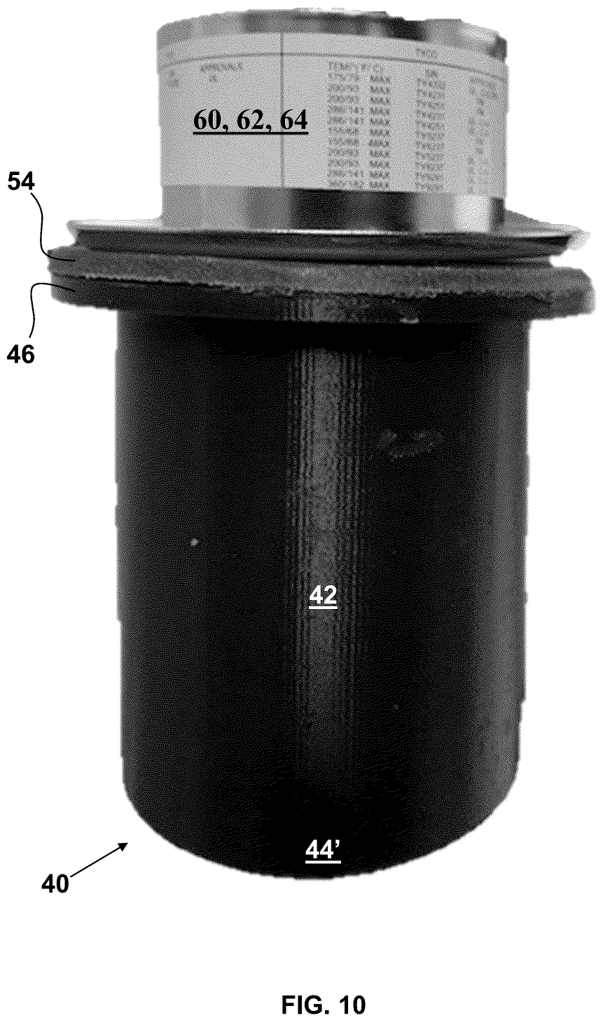

The proximal wall 46 is shaped to receive therethrough a sprinkler head 10, 20. To accommodate a sprinkler head 10, 20, in an exemplary embodiment, the proximal wall 46 defines a central sprinkler opening 47 having a diameter of between 12.7 mm (0.5″) and approximately 25.4 mm (1″), in particular, approximately 19 mm (0.75″). Extending radially outward from the edge of the sprinkler opening 47 are a set of slits 49. In an exemplary embodiment shown in FIGS. 3 and 6, four slits 49 radiate outward from the sprinkler opening 47 at equal distances from one another (e.g., 0°, 90°, 180°, 270°). Other examples of slit sets include three in number (0°, 120°, 240°) and five in number (0°, 72°, 144°, 216°, 288°). The presence of the slits 49 produce intermediate seating flaps 50 that are configured to bend when a sprinkler head 10, 20 being inserted into the sprinkler opening 47 is larger than the sprinkler opening 47 and/or a part of the sprinkler head 10, 20 rubs against the seating flap 50 during such insertion. The exemplary configurations of the slits 49 and the seating flaps 50 of the proximal wall 46 allow the seating flaps 50 to seat upon and/or around any fire sprinkler pipe housing that is connected to the base 12, 22 of the sprinkler head 10, 20 and, at the same time, to slide easily over the suppressant distribution plate 16, 26 and the cages 18, 28 of the base 12, 22. The flexible integrated seating flaps 50 allow the sprinkler head guard 40 to grab and hold into place in almost any condition of the sprinkler head 10, 20 as well as during sprinkler head 10, 20 installation. In an advantageous exemplary configuration, temporary securing device 52 (such as a ring-shaped magnet 52 depicted in dashed lines in FIG. 6) can be attached to or be integral with the proximal wall 46 to act as a rim for an optional escutcheon mounting. This temporary securing device 52 can take other shapes including, for example, a set of line segments or set of dots or set of arcs spaced around and adjacent the outer edge of the proximal wall 46 (the latter of which can be arc segments of the dashed lines depicted in FIG. 6). The temporary securing device 52 can be a temporary adhesive in another alternative exemplary configuration, but can also be combined with the magnet. FIGS. 7, 8, and 9 show sprinkler heads 10, 20 in various types of escutcheon mountings including a recessed escutcheon 60, a flat escutcheon 62, and a protruding escutcheon 64. Advantageously, the sprinkler head guard 40 is able to cover and protect each of these escutcheon mountings 60, 62, 64, as is shown, for example, in FIG. 10. The exemplary embodiment of the sprinkler head guard 40 of FIG. 10 shows an optional flexible washer/liner/gasket 54 placed between the proximal wall 46 and the escutcheon 60, 62, 64. This has the added advantage of forming the sprinkler opening 47 and slits 49 in the gasket 54 instead of in the proximal wall 46, thereby allowing gasket to be made of a relatively softer material and the sprinkler head guard 40 to be made of a different material that is harder and/or more protective for the sprinkler head guard 40. The distal wall 44′ in FIG. 10 is formed in an alternative shape as a portion of a sphere or as a complete hemisphere.

The seating flaps 50 of the flexible material can be attached to the seating lip with adhesives, rivets, screws or bolted around the seating lip 48 to hold around the seating lip 48 itself. The material of the seating flap 48 can be the flexible materials but, in an exemplary alternative embodiment, can be bristles of various materials such as those described herein. The bristles can be adhered to or crimped to a metal ring equal to the diameter of the seating lip 48. The sprinkler head guard 40 can also be made with the seating lip 48 infused with magnets adhered by various measures to magnetically adhere the sprinkler head guard 40 to existing sprinkler head metal escutcheons. The magnets can be small and individually mounted or molded into or adhered in the seating lip 48 or they can be a thin flat flexible magnet adhered to the seating lip 48.

One particular exemplary embodiment of the sprinkler head guard 40 has a lateral wall 42 height of approximately 79.375 mm (3.125″), a lateral wall 42 outer diameter of approximately 66.675 mm (2.625″), a seating lip 48 thickness of approximately 3.175 mm (0.125″), a proximal wall 46 diameter of approximately 73.025 mm (2.875″), a sprinkler opening 47 diameter of approximately 19.05 mm (0.75″), and a slit 49 distance of approximately 9.525 mm (0.375″).

In an advantageous embodiment, the sprinkler head guard 40 is a flame-resistant, flexible material.

The systems, apparatuses, and methods described provide a temporary, hot work, fire sprinkler head guard that overcomes the hereinafore-mentioned disadvantages of the heretofore-known devices and methods of this general type and that provide such features with a surety that the fire sprinkler head is protected from accidental discharge during construction, during hot work activities or during any other activities that might have the potential to activate, undesirably, a sprinkler head. The guard still allows for the discharge of the head in the case of a fire event even if accidentally left in place on a sprinkler head after the work is complete. During any construction or repair activity in the vicinity of a fire sprinkler head, the guard protects the temperature sensitive bulb or fusible link from accidental activation from soldering torches and other heat or flame generation, as well as provides protection from inadvertent physical blows from construction activity that might cause the accidental discharge of a head.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. A fire sprinkler head guard, comprising:
a lateral wall comprising a circumferential lower edge and a circumferential upper edge and defining a hollow interior between the lower and upper edges;
a distal base connected to the lower edge about a circumference thereof in a fluid-tight manner; and
a proximal wall connected to the upper edge about a circumference thereof in a fluid-tight manner, the proximal wall defining:
a sprinkler opening shaped and sized to fit therein a fire sprinkler head and comprising an edge; and
at least one slit originating from the edge of the sprinkler opening and extending radially towards the circumferential upper edge.

2. The head guard according to claim 1, wherein the lateral wall, the distal base, and the proximal wall together form an integral, single-piece body.

3. The head guard according to claim 2, wherein the lateral wall, the distal base, and the proximal wall are of a material selected from one or more of aramid, modacrylic, wool, neoprene, closed cell fire-resistant moldable silicone, ceramic, polyester, polyvinyl chloride (PVC or Vinyl), low-density polyethylene (LDPE), polyethylene terephthalate (PET or PETE), polyoxymethylene (POM also referred to as polyacetal, acetal resin, polytrioxane, polyformaldehyde, and paraformaldehyde, and with the trade names DELRIN®/ERTACETAL®/ACETRON®/SUSTARIN C®/POMALUX®, RISHON®), natural and synthetic rubber, high heat-resistant catalyzed silicone rubber, nitrile, ethylene propylene diene monomer (EPDM), styrene-butadiene rubber (SBR), butyl rubber, polybutadiene rubber, silicones, closed cell silicones, fluorosilicone, and heat resistant textiles.

4. The head guard according to claim 3, wherein:
the fire sprinkler head has a temperature sensitive trigger; and
the material is configured to prevent external environmental heat greater than approximately 135° from transferring into the hollow interior in less than approximately 1 minute to permit activation of the temperature sensitive trigger of the fire sprinkler head after that time.

5. The head guard according to claim 1, wherein:
the lateral wall, the distal base, and the proximal wall together form an integral, single-piece cylindrical body; and
the proximal wall is planar.

6. The head guard according to claim 5, wherein the distal base is one of:
planar;
dome-shaped; and
hemispherical.

7. The head guard according to claim 1, wherein the sprinkler opening is centered in the proximal wall and has a diameter of between approximately 12.7 mm and approximately 25.4 mm.

8. The head guard according to claim 1, wherein:
the lateral wall comprises an outer surface; and
the proximal wall comprises a lip protruding from the outer surface.

9. The head guard according to claim 8, wherein the lip protrudes from the outer surface between approximately 1 mm and approximately 4 mm.

10. The head guard according to claim 1, wherein the at least one slit is a set of slits selected from one of:
two slits radiating outward from the sprinkler opening;
three slits radiating outward from the sprinkler opening;
four slits radiating outward from the sprinkler opening; and
five slits radiating outward from the sprinkler opening.

11. The head guard according to claim 10, wherein the set of slits are spaced at equal distances from one another.

12. The head guard according to claim 10, wherein the set of slits defines intermediate bendable flaps therebetween.

13. The head guard according to claim 1, which further comprises at least one magnet at the proximal wall adjacent the sprinkler opening.

14. The head guard according to claim 13, wherein the at least one magnet is ring-shaped and surrounds the sprinkler opening.

15. The head guard according to claim 13, wherein the at least one magnet is one of attached to and integral with the proximal wall.

16. The head guard according to claim 1, wherein the sprinkler opening is sized to self-secure around the fire sprinkler head.

17. The head guard according to claim 1, wherein at least one of the lateral wall and the distal base have a fluorescent exterior color.

18. The head guard according to claim 1, wherein the sprinkler opening is sized to fit over the fire sprinkler head that is at least one of:
a recessed fire sprinkler head;
a non-recessed fire sprinkler head;
a sidewall fire sprinkler head;
an upright fire sprinkler head;
an over fire sprinkler head; and
an exposed fire sprinkler head.

19. The head guard according to claim 1, wherein the proximal wall is of a first material having a given hardness and an outer surface, and which further comprises a flexible gasket at the outer surface of the proximal wall, the gasket being of a second material that is softer relative to the first material.

20. The head guard according to claim 1, wherein the lateral wall, the distal base, and the proximal wall have a weight that permits ejection of the head guard from the fire sprinkler head when the fire sprinkler head discharges fire-dousing suppressant.

21. The head guard according to claim 5, wherein the lateral wall has:
a cross-sectional shape with an interior diameter between approximately 38 mm and approximately 102 mm; and
a height between approximately 76 mm and approximately 152 mm.

22. The head guard according to claim 1, wherein the lateral wall has a cross-sectional shape selected from one of circular, ovular, triangular, square, pentagonal, hexagonal, septagonal, and octagonal.

23. The head guard according to claim 1, wherein the hollow interior has an inner diameter of between approximately 38 mm and approximately 102 mm.

24. The head guard according to claim 1, wherein the lateral wall has a thickness of approximately 1 mm to approximately 3 mm.

25. A fire sprinkler head guard, comprising:
a lateral wall comprising an outer surface, a circumferential lower edge, and a circumferential upper edge and defining a hollow interior between the lower and upper edges;
a distal base connected to the lower edge about a circumference thereof in a fluid-tight manner; and
a proximal wall:
connected to the upper edge about a circumference thereof in a fluid-tight manner;
comprising a lip protruding from the outer surface;
defining a sprinkler opening:
sized to fit therein and self-secure around the fire sprinkler head; and
comprising an edge; and
defining a set of slits:
originating from the edge of the sprinkler opening and extending radially towards the circumferential upper edge; and
defining intermediate bendable flaps therebetween;
wherein:
the lateral wall, the distal base, and the proximal wall together form an integral, single-piece body and have a weight that permits ejection of the head guard from the fire sprinkler head when the fire sprinkler head discharges fire-dousing suppressant;
the fire sprinkler head has a temperature sensitive trigger; and
the material is configured to prevent external environmental heat greater than approximately 57° C. from transferring into the hollow interior in less than approximately 1 minute to permit activation of the temperature sensitive trigger of the fire sprinkler head after that time.
